(19) United States
(12) Patent Application Publication
(10) Pub. No.: US 2008/0177543 A1
(43) Pub. Date: Jul. 24, 2008

(54) Stochastic Syllable Accent Recognition

(75) Inventors: Tohru Nagano, Yokohama-shi (JP); Masafumi Nishimura, Yokohama-shi (JP); Ryuki Tachibana, Yokohama-shi (JP); Gakuto Kurata, Yamato-shi (JP)

Correspondence Address: Anne Vachon Dougherty, 3713 Cedar Road, Yorktown Hts, NY, 10598, US

(73) Assignee: International Business Machines Corporation, Armonk, NY (US)

(21) Appl. No.: 11/945,900

(22) Filed: Nov. 27, 2007

(30) Foreign Application Priority Data
Nov. 28, 2006 (JP) 2006-320890

(51) Int. Cl. G10L 15/04

(52) U.S. Cl. 704/253

(57) ABSTRACT

Training wording data indicating the wording of each of the words in training text, training speech data indicating characteristics of speech of each of the words, and training boundary data indicating whether each word in training speech is a boundary of a prosodic phrase are stored. After inputting candidates for boundary data, a first likelihood that each of the a boundary of a prosodic phrase of the words in the inputted text would agree with one of the inputted boundary data candidates is calculated and a second likelihood is calculated. Thereafter, one boundary data candidate maximizing a product of the first and second likelihoods is searched out from among the inputted boundary data candidates, and then a result of the searching is outputted.

### FIELD OF THE INVENTION

The present invention relates to a speech recognition technique. In particular, the present invention relates to a technique for recognizing accents of an inputted speech.

### BACKGROUND OF THE INVENTION

In recent years, attention has been paid to a speech synthesis for reading out an inputted text with natural pronunciation without requiring accompanying information such as a reading of the text. In this speech synthesis technique, in order to generate a speech that sounds natural to a listener, it is important to accurately reproduce not only pronunciations of words, but also accents thereof. If a speech can be synthesized by accurately reproducing a vocal of relatively high H type or relatively low L type for every mora composing words, it is possible to make the resultant speech sound natural to a listener.

A majority of speech synthesis systems currently used are systems constructed by statistically training the systems. In order to statistically train a speech synthesis system which accurately reproduces accents, what is required is a large amount of training data, in which speech data of a text read out by a person are associated with accents used in making the speech. Conventionally, such training data are constructed by having a person listen to speech and assign the accent type. For this reason, it has been difficult to prepare a large amount of the training data.

In contrast to this, if the accent types can be automatically recognized from speech data reading out a text, a large amount of training data can be easily prepared. However, since accents are relative in nature, it is difficult to generate the training data based on data such as voice frequency. As a matter of fact, although automatic recognition of accents on the basis of such speech data has been attempted (refer to Kikuo Emoto, Heiga Zen, Keiichi Tokuda, and Tadashi Kitamura “Accent Type Recognition for Automatic Prosodic Labeling,” Proc. of Autumn Meeting of the Acoustical Society of Japan (September, 2003)), the accuracy is not satisfactory enough to put the recognition to practical use.

### SUMMARY OF THE INVENTION

Against this background, an object of the present invention is to provide a system, a method and a program which are capable of solving the above-mentioned problem. This object is achieved by a combination of characteristics described in the independent claims in the scope of claims. Additionally, the dependent claims define further advantageous specific examples of the present invention.

In order to solve the above mentioned problems, one aspect of the present invention is a system that recognizes accents of an inputted speech, the system including a storage unit, a first calculation unit, a second calculation unit, and a prosodic phrase searching unit. Specifically, the storage unit stores therein: training wording data indicating the wording of each of the words in a training text, training speech data indicating characteristics of speech of each of the words in a training speech, and training boundary data indicating whether each of the words is a boundary of a prosodic phrase. Additionally, the first calculation unit receives input of candidates for boundary data (hereinafter referred to as boundary data candidates) indicating whether each of the words in the inputted speech is a boundary of a prosodic phrase, and then calculates, a first likelihood that each boundary of a prosodic phrase of words in an inputted text would agree with one of the inputted boundary data candidates, on the basis of inputted-wording data indicating the wording of each of the words in an inputted text indicating contents of the inputted speech, the training wording data, and the training boundary data. Subsequently, the second calculation unit receives input of the boundary data candidates and calculates a second likelihood that, in a case where the inputted speech has a boundary of a prosodic phrase specified by any one of the boundary data candidates, and speech of each of the words in the inputted text would agree with speech specified by the inputted-speech data, on the basis of inputted-speech data indicating characteristics of speech of each of the words in the inputted speech, the training speech data and the training boundary data. Furthermore, a prosodic phrase searching unit searches out one boundary data candidate maximizing a product of the first and second likelihoods, from among the inputted boundary data candidates, and then outputs the searched-out boundary data candidate as boundary data for sectioning the inputted text into prosodic phrases. In addition, a method of recognizing accents by means of this system, and a program enabling an information processing system to function as this system, are also provided.

Note that the above described summary of the invention does not list all of necessary characteristics of the present invention, and that sub-combinations of groups of these characteristics can also be included in the invention.

### BRIEF DESCRIPTION OF THE DRAWINGS

For a more complete understanding of the present invention and the advantage thereof, reference is now made to the following description taken in conjunction with the accompanying drawings:

FIG. 1 shows an entire configuration of a recognition system 10.

FIG. 2 shows a specific example of configurations of an input text 15 and training wording data 200.

FIG. 3 shows one example of various kinds of data stored in the storage unit 20.

FIG. 4 shows a functional configuration of an accent recognition unit 40.

FIG. 5 shows a flowchart of processing in which the accent recognition unit 40 recognizes accents.

FIG. 6 shows one example of a decision tree used by the accent recognition unit 40 in recognition of accent boundaries.

FIG. 7 shows one example of a fundamental frequency of a word in proximity to the time when the word is spoken, the word becoming a candidate for a prosodic phrase boundary.

FIG. 8 shows one example of a fundamental frequency of a certain mora subjected to accent recognition.

FIG. 9 shows one example of a hardware configuration of an information processing apparatus 500 which functions as the recognition system 10.

### DETAILED DESCRIPTION OF THE PREFERRED EMBODIMENT(S)

Although the present invention will be described below by way of the best mode (referred to as an embodiment hereinafter) for carrying out the invention, the following embodiment does not limit the invention according to the scope of claims, and all of combinations of characteristics described in the embodiment are not necessarily essential for the solving means of the invention.

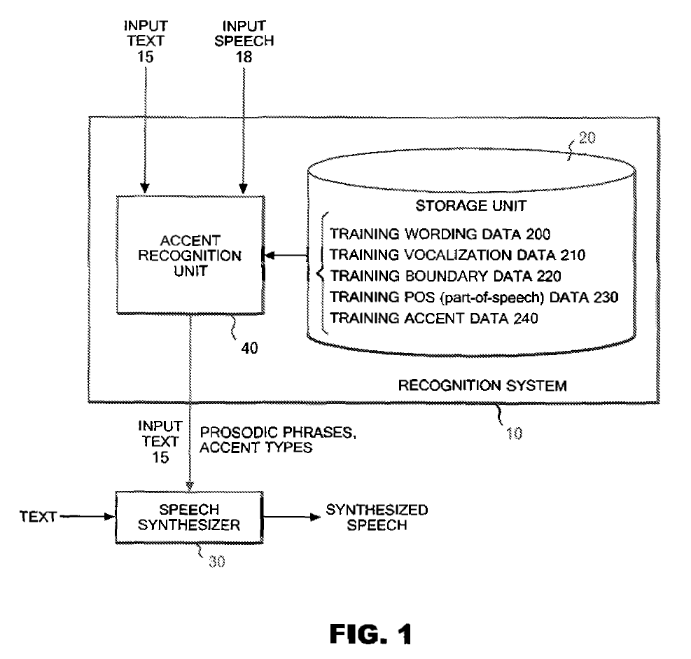

FIG. 1 shows an entire configuration of a recognition system 10. The recognition system 10 includes a storage unit 20 and an accent recognition unit 40. An input text 15 and an input speech 18 are inputted into the accent recognition unit 40, and the accent recognition unit 40 recognizes accents of the input speech 18 thus inputted. The input text 15 is data indicating contents of the input speech 18, and is, for example, data such as a document in which characters are arranged. Additionally, the input speech 18 is a speech reading out the input text 15. This speech is converted into acoustic data indicating time series variation and the like in frequency, or into inputted-speech data indicating characteristics and the like of the time series variation, and then, is recorded in the recognition system 10. Moreover, an accent signifies, for example, information indicating, for every mora in the input speech 18, whether the mora belongs to an H type indicating that the mora should be spoken with a relatively high voice, or belongs to an L type indicating that the mora should be spoken with a relatively low voice. In order to recognize the accents, various kinds of data stored in the storage unit 20 are used in addition to the input text 15 inputted in association with the input speech 18. The storage unit 20 has training wording data 200, training speech data 210, training boundary data 220, training part-of-speech data 230 and training accent data 240 stored therein. An object of the recognition system 10 according to this embodiment is to accurately recognize the accents of the input speech 18 by effectively utilizing these data.

Note that each of the thus recognized accents is composed of boundary data indicating segmentation of prosodic phrases, and information on accent types of the prosodic phrases. The recognized accents are associated with the input text 15 and are outputted to an external speech synthesizer 30. By using the information on the accents, the speech synthesizer 30 generates from a text, and then outputs a synthesized speech. With the recognition system 10 according to this embodiment, the accents can be efficiently and highly accurately recognized by a mere input of the input text 15 and the input speech 18. Accordingly, time and trouble can be saved for manually inputting accents and for correcting automatically recognized accents, to enable efficient generation of a large amount of data in which a text is associated with the reading. For this reason, highly reliable statistic data on accents can be obtained in the speech synthesizer 30, whereby a speech that sounds more natural to the listener can be synthesized.

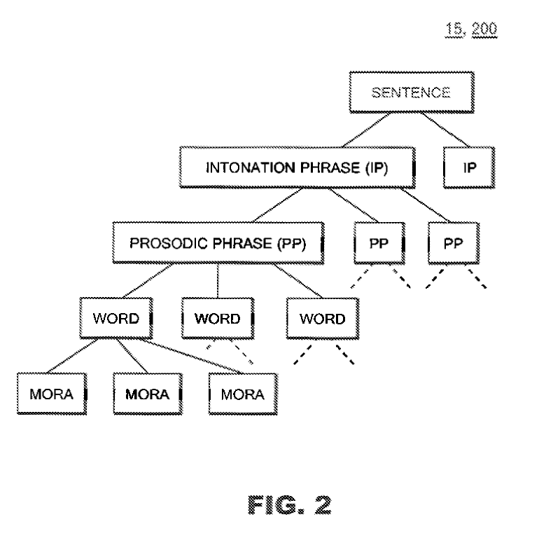

FIG. 2 shows a specific example of configurations of the input text 15 and the training wording data 200. The input text 15 is, as has been described, data such as a document where characters are arranged, and the training wording data 200 is data showing wordings of each word in a previously prepared training text. Each piece of data includes a plurality of sentences segmented from one another, for example, by so-called “kuten” (periods) in Japanese. In addition, each of the sentences includes a plurality of intonation phrases (IP) segmented from one another, for example, by so-called “touten” (commas) in Japanese. Each of the intonation phrases further includes prosodic phrases (PP). A prosodic phrase is, in the field of prosody, a group of words spoken continuously.

In addition, each of the prosodic phrases includes a plurality of words. A word is mainly a morpheme, and is a concept indicating the minimum unit having a meaning in a speech. Additionally, a word includes a plurality of moras as a pronunciation thereof. A mora is, in the field of prosody, a segment unit of speech having a certain length, and is, for example, a pronunciation corresponding to one character of “hiragana” (a phonetic character) in Japanese.

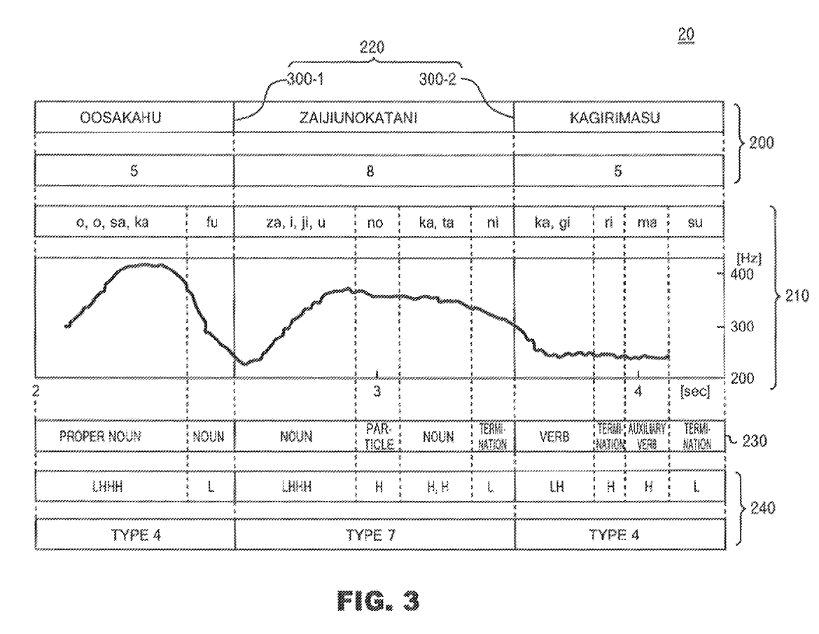

FIG. 3 shows one example of various kinds of data stored in storage unit 20. As has been described above, the storage unit 20 has the training wording data 200, the training speech data 210, the training boundary data 220, the training part-of-speech data 230 and the training accent data 240. The training wording data 200 contains a wording of each word, for example, as data of continuous plural characters. In the example of FIG. 3, data of each one of characters in a sentence “oo saka hu zai ji u no kata ni kagi ri ma su” corresponds to this data. Additionally, the training wording data 200 contains data on boundaries between words. In the example of FIG. 3, the boundaries are shown by dotted lines. Specifically, each of “oosaka”, “fu”, “zaijiu”, “no”, “kata”, “ni”, “kagi”, “ri”, “ma” and “su” is a word in the training wording data 200. Furthermore, the training wording data 200 contains information indicating the number of moras in each word. In the drawing, exemplified are the numbers of moras in each of the prosodic phrases, which can be easily calculated on the basis of the numbers of moras in each of the words.

The training speech data 210 is data indicating characteristics of speech of each of the words in a training speech. Specifically, the training speech data 210 may include character strings of alphabets expressing pronunciations of the corresponding words. That is, information that a phrase written as “oosakafu” includes five moras as a pronunciation thereof, and is pronounced as “o, o, sa, ka, fu” corresponds to this character string. Additionally, the training speech data 210 may include data of frequency of speech reading out the words in the training speech. This frequency data is, for example, an oscillation frequency of a vocal band, and is preferably obtained by excluding a frequency which has resonated inside the oral cavity, which frequency is called a fundamental frequency. Additionally, the training speech data 210 may store this fundamental-frequency data not in the form of values of the frequency themselves, but in the form of data such as a slope of a graph showing time series variation of those values.

The training boundary data 220 is data indicating whether each of the words in the training text correspond to a boundary of a prosodic phrase. In the example of FIG. 3, the training boundary data 220 includes a prosodic phrase boundary 300-1 and a prosodic phrase boundary 300-2. The prosodic phrase boundary 300-1 indicates that an ending of the word “fu” corresponds to a boundary of a prosodic phrase. The prosodic phrase boundary 300-2 indicates that an ending of the word “ni” corresponds to a boundary of a prosodic phrase. The training part-of-speech data 230 is data indicating part-of-speeches of the words in the training text. The part-of-speeches mentioned here is a concept including not only part-of-speeches in a strict grammatical sense but also ones into which these part-of-speeches are further classified in detail on the basis of roles thereof. For example, the training part-of-speech data 230 includes, in association with the word “oosaka”, information on the part-of-speeches that it is a “proper noun”. Meanwhile, the training part-of-speech data 230 includes, in association with the word “kagi”, information on the part-of-speeches that it is a “verb”. The training accent data 240 is data indicating accent types of each word in the training text. Each mora contained in each prosodic phrase is classified into the H type or the L type.

Additionally, an accent type of a prosodic phrase is determined by classifying the phrase into any one of a plurality of predetermined accent types. For example, in a case where a prosodic phrase composed of five moras is pronounced by continuous accents “LHHHL”, the accent type of the prosodic phrase is Type 4. The training accent data 240 may include data directly indicating the accent types of the prosodic phrases, may include only data indicating whether each mora is the H type or the L type, or may include both kinds of data.

The various kinds of data are valid information having been analyzed, for example, by an expert in linguistics or in language recognition, or the like. By having the storage unit 20 storing such valid information, the accent recognition unit 40 can accurately recognize accents of an inputted speech by using this information.

Note that, for the purpose of simplifying the description, FIG. 3 has been described, as an example, by taking a case where the training wording data 200, the training speech data 210, the training boundary data 220, the training part-of-speech data 230 and the training accent data 240 are known uniformly for all of relevant words. Instead, the storage unit 20 may store all data excluding the training speech data 210 for a first training text that is larger in volume, and store all data for a second training speech corresponding to a second training text that is smaller in volume. Since the training speech data 210 are data strongly dependent on the speaker of the words in general, the data are difficult to collect in a large amount. In contrast, the training accent data 240, the training wording data 200 and the like are often general data independent from attributes of the speaker, and are easy to collect. In this manner, stored volumes of data may vary among the respective training data depending on the easiness in collecting. With the recognition system 10 according to this embodiment, after likelihoods are evaluated independently with respect to linguistic and acoustic information, prosodic phrases are recognized on the basis of the product of those likelihoods. Accordingly, in spite of the variation in stored volumes of data, accuracy of the recognition is maintained. Furthermore, highly accurate accent recognition is made possible by reflecting therein characteristics of speech which vary by the speaker.

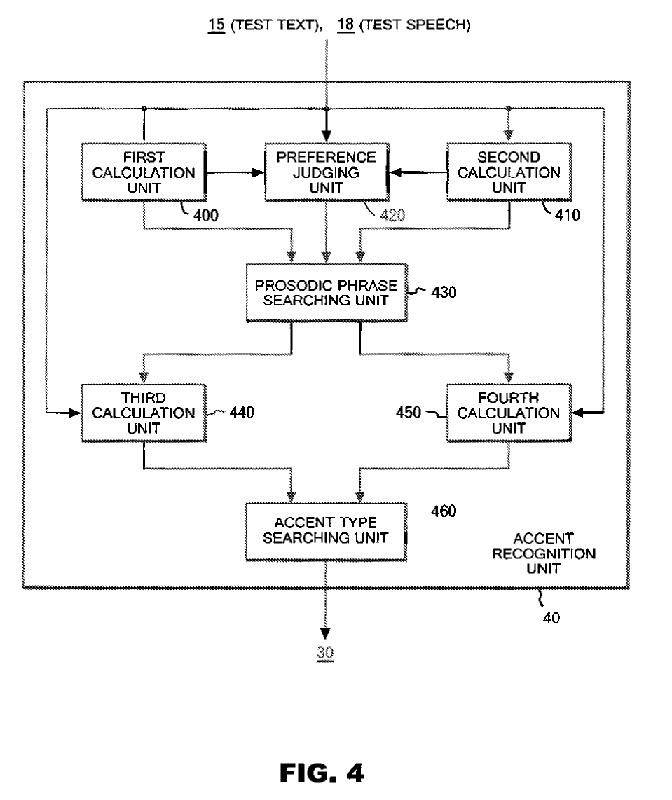

FIG. 4 shows a functional configuration of the accent recognition unit 40. The accent recognition unit 40 includes a first calculation unit 400, a second calculation unit 410, a preference judging unit 420, a prosodic phrase searching unit 430, a third calculation unit 440, a fourth calculation unit 450, and an accent type searching unit 460. First of all, relations between hardware resources and each of the units shown in this figure will be described. A program implementing the recognition system 10 according to the present invention is firstly read by a later-described information processing system 500, and is then executed by a CPU 1000. Subsequently, the CPU 1000 and a RAM 1020, in collaboration with each other, enable the information processing apparatus 500 to function as the storage unit 20, the first calculation unit 400, the second calculation unit 410, the preference judging unit 420, the prosodic phrase searching unit 430, the third calculation unit 440, the fourth calculation unit 450, and the accent type searching unit 460.

Data to be actually subjected to accent recognition, such as the input text 15 and the input speech 18, are inputted into the accent recognition unit 40 in some cases, and a test text and the like of which accents have been previously recognized are inputted prior to accent recognition in other cases. Here, firstly described is a case where data to be actually subjected to accent recognition are inputted.

After input of the input text 15 and the input speech 18, prior to processing by the first calculation unit 400, the accent recognition unit 40 performs the following steps. Firstly, the accent recognition unit 40 divides the input text 15 into segments of words, concurrently generating information on part-of-speeches in association with each word by performing morphological analysis on the input text 15. Secondly, the accent recognition unit 40 analyzes the number of moras in the pronunciation of each word, extracts a part corresponding to the word from the input speech 18, and then associates the number of moras with the word. In a case where the inputted input text 15 and the input speech 18 have already undergone the morphological analysis, these processing are unnecessary.

Hereinbelow, recognition of prosodic phrases by use of combination of a linguistic model and an acoustic model, and recognition of accent types by use of the same combination of models will be described sequentially. Recognition of prosodic phrases by a linguistic model is, for example, to employ a tendency that endings of words of particular class words, and particular wordings, are likely to be boundaries of a prosodic phrase, the words previously obtained from the training text. This processing is implemented by the first calculation unit 400. Recognition of prosodic phrases by an acoustic model is, to employ a tendency that a boundary of a prosodic phrase is likely to appear following voices of particular frequencies and change in frequency, the sounds of particular frequencies and change in frequency previously obtained from the training speech. This processing is implemented by the second calculation unit 410.

The first calculation unit 400, the second calculation unit 410 and the prosodic phrase searching unit 430 perform the following processing for every intonation phrase into which each of the sentences is segmented by commas and the like. Inputted to the first calculation unit are candidates for boundary data indicating whether each of the words in the inputted speech corresponding to each of these intonation phrases is a boundary of a prosodic phrase. Each of these boundary data candidates is expressed, for example, as a vector variable of which: elements are logical values indicating whether endings of the words is a boundary of a prosodic phrase; and the number of elements is a number obtained by subtracting 1 from the number of words. In order to search the most probable combination from among all of combinations assumable as a boundary of a prosodic phrase, preferably, combinations for all of the cases where each of the words is set or not set as a boundary of a prosodic phrase are sequentially inputted into the first calculation unit 400 as boundary data candidates.

Then, for each of these boundary data candidates, the first calculation unit 400 calculates a first likelihood on the basis of: inputted-wording data indicating wordings of the words in the input text 15; the training wording data 200 read out from the storage unit 20; the training boundary data 220; and the training part-of-speech data 230. The first likelihood indicates the likelihood of each boundary of a prosodic phrase of the words in the input text 15 becoming a boundary data candidate. As in the case with the first calculation unit 400, the boundary data candidates are sequentially inputted into the second calculation unit 410. Then, the second calculation unit 410 calculates a second likelihood on the basis of: inputted-speech data indicating characteristics of speech of the respective words in the input speech 18; the training speech data 210 read out from the storage unit 20; and the training boundary data 220. The second likelihood indicates the likelihood that, in a case where the input speech 18 has a boundary of a prosodic phrase which is specified by the boundary data candidates, speech of the respective words agrees with speech specified by the inputted-speech data.

Then, the prosodic phrase searching unit 430 searches out one boundary data candidate from among these boundary data candidates, and outputs, as the boundary data segmenting the input text 15 into prosodic phrases, the one boundary data candidate that has been searched out, the one candidate maximizing a product of the calculated first and second likelihoods. The above processing is expressed by Equation 1 shown below:

$$\begin{matrix}B max = {arg max}_{B} P ( B \vert W , V ) \\ = {arg max}_{B} \frac{P ( B \vert W ) P ( B \vert W , V )}{P ( V \vert W )} \\ = {arg max}_{B} P ( B \vert W ) P ( B \vert W , V )\end{matrix} \qquad Equation 1$$

In this equation, the vector variable V is the inputted-speech data indicating the characteristics of speech of the words in the input speech 18. As indicators indicating the characteristics of the input speech 18, this inputted-speech data may be inputted from the outside, or may be calculated by the first calculation unit 400 or the second calculation unit 410. When r denotes the number of words, and vᵣ denotes each indicator of the characteristics of speech of each word, V is expressed as V=(v₁, . . . , vᵣ). Additionally, the vector variable W is the inputted-wording data indicating wordings of the words in the input text 15. When wᵣ denotes the wording of each of the words, the variable W is expressed as W=(w₁, . . . , wᵣ). Additionally, the vector variable B indicates the boundary data candidates. When bᵣ=1 denotes a case where an ending of the word wᵣ is a boundary of a prosodic phrase, and bᵣ=0 denotes the case where the ending of the word wᵣ is not the boundary, B is expressed as B=(b₁, . . . , bᵣ₋₁). Additionally, argmax is a function for finding B maximizing P(B|W,V) described subsequently to argmax in Equation 1. That is, the first line of Equation 1 expresses a problem of finding a prosodic phrase boundary column Bₘₐₓ having a maximum likelihood by maximizing a conditional probability of B on condition that V and W are known.

On the basis of the definition of conditional probability, the first line of Equation 1 is transformed into an expression in the second line of Equation 1. Then, since P(V|W) is constant, independent of the boundary data candidates, the second line of Equation 1 is transformed into an expression in the third line of Equation 1. Furthermore, P(V|B,W) appearing on the right-hand side of the third line of Equation 1 indicates that amounts of characteristics of speech are determined on the basis of a boundary of a prosodic phrase and wordings of the words. Meanwhile, P(V|B,W) can be approximated by P(V|B) on the assumption that these amounts of characteristics are each determined by existence or nonexistence of a boundary of a prosodic phrase. As a result, the problem of finding the prosodic phrase boundary column Bₘₐₓ is expressed as the product of P(B|W) and P(V|B). P(B|W) is the first likelihood calculated by the aforementioned first calculation unit 400, and P(V|B) is the second likelihood calculated by the aforementioned second calculation unit 410. Consequently, the processing of finding B maximizing the product of the two corresponds to the searching processing performed by the prosodic phrase searching unit 430.

Subsequently, recognition of accent types implemented by combining a linguistic model and an acoustic model will be described sequentially. Recognition of accent types using a linguistic model is, for example, to employ a tendency that particular part-of-speeches and wordings previously obtained from the training text are likely to form particular accent types, when considering together the wordings of words immediately before and after. This processing is implemented by the third calculation unit 440. Recognition of accent types using an acoustic model is, for example, to employ a tendency that voices having particular frequencies and words having frequency change, both previously obtained from the training speech, are likely to form certain accent types. This processing is implemented by the fourth calculation unit 450.

For each prosodic phrase segmented by the boundary data searched out by the prosodic phrase searching unit 430, candidates for accent types of the words in each of the prosodic phrases are inputted to the third calculation unit 440. Also for these accent types, similar to the aforementioned case with the boundary data, it is desirable that all of the combinations, assumed to function as accent types, of the words composing the prosodic phrases be sequentially inputted as the plural candidates for the accent types. For each of the inputted candidates for the accent types, the third calculation unit 440 calculates a third likelihood on the basis of the inputted-speech data, the training wording data 200 and the training accent data 240. The third likelihood indicates the likelihood that the accent types of the words in each of the prosodic phrases agree with each of the inputted candidates for the accent types.

Simultaneously, for each of prosodic phrases segmented by the boundary data searched out by the prosodic phrase searching unit 430, candidates for accent types of the words in each of the prosodic phrases are sequentially inputted to the fourth calculation unit 450. Then, for each of the inputted candidates for the accent types, the fourth calculation unit 450 calculates a fourth likelihood on the basis of the inputted-speech data, the training speech data 210 and the training accent data 240. The fourth likelihood indicates the likelihood that in a case where the words in each of the prosodic phrases have accent types specified by the inputted candidates for the accent types, speech of the respective prosodic phrases agrees with speech specified by the inputted-speech data.

Then, the accent type searching unit 460 searches out one candidate for accent types from among the plural inputted candidates, the one candidate maximizing a product of the third likelihood calculated by the third calculation unit 440 and the fourth likelihood calculated by the fourth calculation unit 450. This searching may be performed by calculating the products of third and forth likelihoods for each of the candidates for the accent types, and thereafter specifying one candidate for the accent types which corresponds to a maximum value among those products. Thereafter, the accent type searching unit 460 outputs the searched out candidate for accent type as the accent type of the prosodic phrase, to the speech synthesizer 30. Preferably, the accent types are outputted in association with the input text 15 and with boundary data indicating a boundary of a prosodic phrase.

The above processing is expressed by Equation 2 shown below:

$$\begin{matrix}A max = {arg max}_{A} P ( A \vert W , V ) \\ = {arg max}_{A} \frac{P ( A \vert W ) P ( V \vert W , A )}{P ( V \vert W )} \\ = {arg max}_{A} P ( V \vert W , A ) P ( A \vert W )\end{matrix} \qquad Equation 2$$

As in the case with Equation 1, the vector variable V is the inputted-speech data indicating the characteristics of speech of the words in the input speech 18. However, in Equation 2, the vector variable V is an index value indicating characteristics of speech of moras in a prosodic phrase subjected to the processing. When m denotes the number of moras in the prosodic phrase, and vₘ denotes each indicator indicating the characteristics of speech of each mora, V is expressed as V=(v₁, . . . , vₘ). Additionally, the vector variable W is the inputted-wording data indicating wordings of the words in the input text 15. When wₙ denotes each of the wordings of each of the words, the variable W is expressed as W=(w₁, . . . , wₙ). Additionally, the vector variable A indicates the combination of accent types of each of the words in the prosodic phrase. Additionally, argmax is a function for finding A maximizing P(A|W,V) described subsequently to argmax in Equation 2. That is, the first line of Equation 2 expresses a problem of finding an accent type combination A having a maximum likelihood by maximizing a conditional probability of A on condition that V and W are known.

On the basis of the definition of conditional probability, the first line of Equation 2 is transformed into an expression as shown in the second line of Equation 2. Then, since P(V|W) is constant, independent of accent types, the second line of Equation 2 is transformed into an expression in the third line of Equation 2. P(V|W, A) is the third likelihood calculated by the aforementioned third calculation unit 440, and P(A|W) is the fourth likelihood calculated by the aforementioned fourth calculation unit 450. Consequently, the processing of finding A maximizing the product of the two corresponds to the searching processing performed by the accent type searching unit 460.

Next, a processing function of inputting the test text will be described. Into the accent recognition unit 40, the test text of which a boundary of a prosodic phrase is previously recognized is inputted instead of the input text 15, and test speech data indicating pronunciations of the test text is inputted instead of the input speech 18. Then, on the assumption that the boundaries between the test speech data are yet to be recognized, the first calculation unit 400 calculates the first likelihoods by performing on the test text the same processing as that performed on the input speech 18. Meanwhile, the second calculation unit 410 calculates the second likelihoods by using the test text instead of the input text 15, the test speech data instead of the input speech 18. Thereafter, the preference judging unit 420 judges that, out of the first and second calculation units 400 and 410, the calculation unit having calculated the higher likelihood for previously recognized boundary of a prosodic phrase for the test speech data is a preferential calculation unit which should be preferentially used. Then, the preference judging unit 420 informs the prosodic phrase searching unit 430 of a result of the judgment. In response, in the aforementioned step of searching the prosodic phrases for the input speech 18, the prosodic phrase searching unit 430 calculates the products of the first and second likelihoods after assigning larger weights to likelihoods calculated by the preferential calculation unit. Thereby, more reliable likelihoods can be utilized in the searching for prosodic phrases since preference is given to the more reliable likelihoods. Likewise, by using the test speech data and the test text of which a boundary of a prosodic phrase is previously recognized, the preference judging unit 420 may make a judgment for giving preference, either to the third calculation unit 440 or to the fourth calculation unit 450.

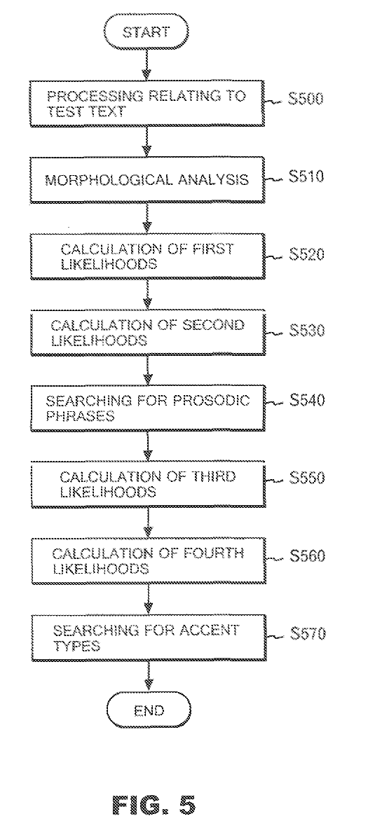

FIG. 5 shows a flowchart of processing in which the accent recognition unit 40 recognizes accents. First of all, by using the test text and the test speech data, the accent recognition unit 40 judges: which likelihoods to evaluate higher, the likelihoods calculated by the first calculation unit 400 or those calculated by the second calculation unit 410; and/or which likelihoods to evaluate higher, the likelihoods calculated by the third calculation unit 440 or those calculated by the fourth calculation unit 450 (S500). Subsequently, once the input text 15 and the input speech 18 are inputted, according to need, the accent recognition unit 40 performs: morphological analysis processing; processing of associating words with speech data of these words; processing of counting numbers of moras in the respective words and the like (S510).

Next, the first calculation unit 400 calculates the first likelihoods for the inputted boundary data candidates, that is, for example, for every one of the boundary data candidates assumable as the boundary data in the input text 15 (S520). As has been described above, the calculation of each of the first likelihoods corresponds to the calculation of P(B|W) in the third line of Equation 1. Additionally, this calculation is implemented, for example, by Equation 3 shown below.

$$\begin{matrix}P ( B \vert W ) = P ( {b}_{1} , … , {b}_{l - 1} \vert W ) \\ = P ( {b}_{1} \vert W ) {\prod }_{i = 2}^{l - 1} P ( {b}_{i} \vert {b}_{1} , … , {b}_{i - 1} , W ) \\ = P ( {b}_{1} \vert {w}_{1} , {w}_{2} ) {\prod }_{i = 2}^{l - 1} P ( {b}_{i} \vert {b}_{i - 1} , {w}_{i} , {w}_{i + 1} )\end{matrix} \qquad Equation 3$$

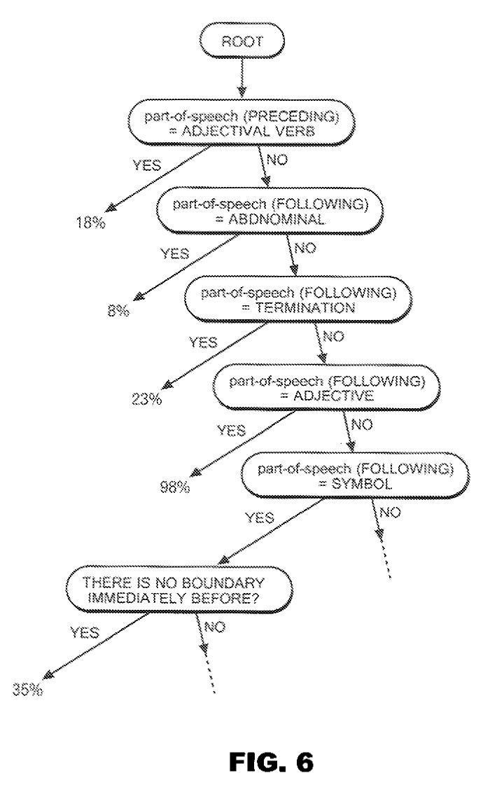

In the first line of Equation 3, the vector variable B is expanded on the basis of a definition thereof. However, the number of words contained in each of the intonation phrases is denoted by 1 in this equation. The second line of Equation 3 is the result of a transformation on the basis of the definition of conditional probability. This equation indicates that the likelihood of a certain boundary data B is calculated in the following manner. Firstly, by scanning boundaries between words from the beginning of each of the intonation phrases, and then by sequentially multiplying probabilities of each of the cases in which boundaries between the words are/are not a boundary of a prosodic phrase. As shown by wᵢ and wᵢ₋₁ in the third line of Equation 3, a probability value indicating whether the ending of a certain word wᵢ is a boundary of a prosodic phrase may be determined on the basis of the subsequent word wᵢ₊₁ as well as the word wᵢ. Furthermore, the probability value may be determined by information bᵢ₋₁ indicating whether a word immediately before the word wᵢ is a boundary of a prosodic phrase. P(b|W) may be calculated by using a decision tree. One example of the decision tree is shown in FIG. 6.

FIG. 6 shows one example of the decision tree used by the accent recognition unit 40 in recognition of accent boundaries. This decision tree is used for calculating the likelihood that an ending of a certain word is a boundary of a prosodic phrase. The likelihood is calculated by using, as explanatory variables, information indicating a wording, information indicating a part-of-speech of the certain word, and information indicating whether an ending of another word immediately before the certain word is a boundary of a prosodic phrase. A decision tree of this kind is automatically generated by giving conventionally known software for decision tree construction the following information including: identification information of parameters that become explanatory variables; information indicating accent boundaries desired to be predicted; the training wording data 200; the training boundary data 220; and the training part-of-speech data 230.

The decision tree shown in FIG. 6 is used for calculating the likelihood indicating whether an ending part of a certain word wᵢ is a boundary of a prosodic phrase. For example, the first calculation unit 400 judges, on the basis of morphological analysis performed on the input text 15, whether a part-of-speech of the word wᵢ is an adjectival verb. If the part-of-speech is an adjectival verb, the likelihood that the ending part of the word wᵢ is a boundary of a prosodic phrase is judged to be 18%. If the part-of-speech is not an adjectival verb, the first calculation unit 400 judges whether the part-of-speech of the word wᵢ is an adnominal. If the part-of-speech is an adnominal, the likelihood that the ending part of the word wᵢ is a boundary of a prosodic phrase is judged to be 8%. If the part-of-speech is not an adnominal, the first calculation unit 400 judges whether a part-of-speech of a word wᵢ₊₁ subsequent to the word wᵢ is a “termination”. If the part-of-speech is a “termination”, the first calculation unit 400 judges that the likelihood that the ending part of the word wᵢ is a boundary of a prosodic phrase is 23%. If the part-of-speech is not a “termination”, the first calculation unit 400 judges whether the part-of-speech of the word wᵢ₊₁ subsequent to the word wᵢ is an adjectival verb. If the part-of-speech is an adjectival verb, the first calculation unit 400 judges that the likelihood that the ending part of the word wᵢ is a boundary of a prosodic phrase is 98%.

If the part-of-speech is not an adjectival verb, the first calculation unit 400 judges whether the part-of-speech of the word wᵢ₊₁ subsequent to the word wᵢ is a “symbol”. If the part-of-speech is a “symbol”, the first calculation unit 400 judges, by using bᵢ₋₁, whether an ending of a word wᵢ₋₁ immediately before the word wᵢ is a boundary of a prosodic phrase. If the ending is not a boundary of a prosodic phrase, the first calculation unit 400 judges that the likelihood that the ending part of the word wᵢ is a boundary of a prosodic phrase is 35%.

Thus, the decision tree is composed of: nodes expressing judgments of various kinds; edges indicating results of the judgments; and leaf nodes indicating likelihoods that should be calculated. As kinds of information used in the judgments, wordings themselves may be used in addition to information, such as part-of-speeches, which are exemplified in FIG. 6. That is, for example, the decision tree may include a node for deciding, in accordance with whether a wording of a word is a predetermined wording, to which child node the node should transition. By using this decision tree, for each of the inputted boundary data candidates, after calculating likelihoods of prosodic phrases indicated by each of the candidates, the first calculation unit 400 can calculate, as the first likelihood, a product of the thus calculated likelihoods.

FIG. 5 will be referred to here again. Subsequently, the second calculation unit 410 calculates the second likelihoods for the inputted boundary data candidates, for example, for all of the boundary data candidates that are assumable as the boundary data in the input text 15 (S530). As has been described above, calculation of each of the second likelihoods corresponds to calculation of P(V|B). In addition, this calculation processing is expressed, for example, as Equation 4 shown below.

$$P ( B \vert W ) = {\prod }_{i = 1}^{l - 1} P ( {v}_{i} \vert {b}_{i} ) \qquad Equation 4$$

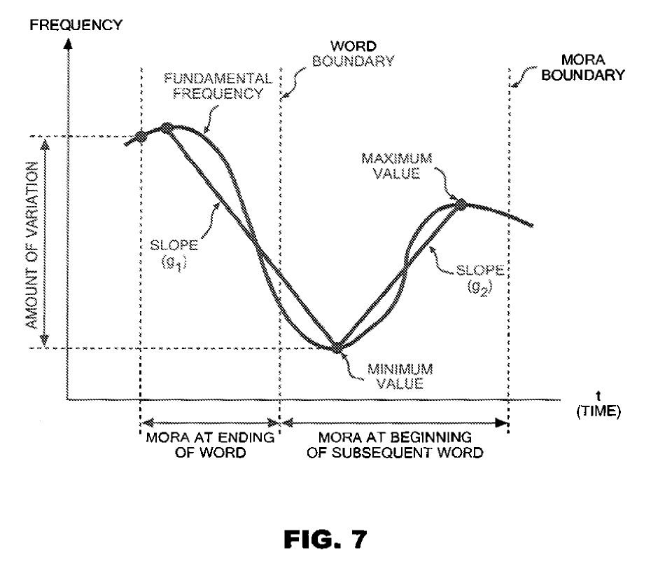

In Equation 4, definitions of the variables V and B are the same as those described above. Additionally, the left-hand side of Equation 4 is transformed into an expression as shown on the right-hand side thereof. Equation 4 is transformed on the assumption that characteristics of speech of a certain word are determined subject to whether the certain word is a boundary of a prosodic phrase, and that those characteristics are independent of characteristics of words adjacent to the certain word. In P(vᵢ|bᵢ), the variable vᵢ is the vector variable composed of a plurality of indicators indicating characteristics of speech of the word wᵢ. Index values are calculated, on the basis of the input speech 18, by the second calculation unit 410. The indicator signified by each element of the variable vᵢ will be described with reference to FIG. 7.

FIG. 7 shows one example of a fundamental frequency of a word in proximity to the time when the word is spoken, the word becoming a candidate for a prosodic phrase boundary. The horizontal axis represents elapse of time, and the vertical axis represents a fundamental frequency. Additionally, the curved line in the graph indicates change in a fundamental frequency of the training speech. As a first indicator indicating a characteristic of the speech, a slope g₂ in the graph is exemplified. This slope g₂ is an indicator which, by using the word wᵢ as a reference, indicates a change in the fundamental frequency over time in a mora located at the beginning of a subsequent word pronounced continuously after the word wᵢ. This indicator is calculated as a slope of change between the minimum and the maximum value in the fundamental frequency in the mora located at the beginning of the subsequent word.

A second indicator indicating another characteristic of the speech is expressed as, for example, the difference between a slope g₁ in the graph and the slope g₂. The slope g₁ indicates change in the fundamental frequency over time in a mora located at the ending of the word wᵢ used as a reference. This slope g₁ may be approximately calculated, for example, as a slope of change, between the maximum value of the fundamental frequency in the mora located at the ending of the word wᵢ, and the minimum value in the mora located at the beginning of the subsequent word following the word wᵢ. Additionally, a third indicator indicating another characteristic of the speech is expressed as an amount of change in the fundamental frequency in the mora located at the ending of the reference word wᵢ. This amount of change is, specifically, the difference between a value of the fundamental frequency at the start of this mora, and a value thereof at the end of this mora.

Instead of the actual fundamental frequency and amount of change thereof, their logarithms may be employed as the indicators. Additionally, for the input speech 18, index values are calculated by the second calculation unit 410 with respect to each word therein. Additionally, for the training speech, index values may previously be calculated with respect to each word therein, and be stored in the storage unit 20. Alternatively, for the training speech, these index values may be calculated, on the basis of data of the fundamental frequency stored in the storage unit 20, by the second calculation unit 410.

For both cases where the ending of the word wᵢ is and is not a boundary of a prosodic phrase the second calculation unit 410 generates probability density functions, on the basis of these index values and the training boundary data 220. To be specific, the second calculation unit 410 generates probability density functions by using as a stochastic variable a vector variable containing each of the indicators of the word wᵢ, the probability density functions each indicating a probability that speech of the word wᵢ agrees with speech specified by a combination of the indicators.

These probability density functions are each generated by approximating, to a continuous function, a discrete probability distribution found on the basis of the index values observed discretely word by word. Specifically, the second calculation unit 410 may generate these probability density functions by determining parameters of Gaussian mixture on the basis of the index values and the training boundary data 220.

By using the thus generated probability density functions, the second calculation unit 410 calculates the second likelihood that, in a case where an ending part of each word contained in the input text 15 is a boundary of a prosodic phrase, speech of the input text 15 agrees with speech specified by the input speech 18. Specifically, first of all, on the basis of the inputted boundary data candidates, the second calculation unit 410 sequentially selects one of the probability density functions with respect to each word in the input text 15. For example, during scanning each of the boundary data candidates from the beginning thereof, the second calculation unit 410 makes a selection as follows.

When the ending of a certain word is a boundary of a prosodic phrase, the second calculation unit 410 selects the probability density function for a case where a word is the boundary. Instead, when the ending of a word subsequent to the certain word is not a boundary of a prosodic phrase, the second calculation unit 410 selects the probability density function for a case where the word is not the boundary.

Then, into the probability density function selected for the each word, the second calculation unit 410 substitutes a vector variable of the index values corresponding to each word in the input speech 18. Each of calculated values thus calculated corresponds to P(vᵢ|bᵢ) shown on the right-hand side of Equation 4. Then, the second calculation unit 410 is allowed to calculate the second likelihood by multiplying together the calculated values.

FIG. 5 will be referred to here again. Next, from among other candidates, the prosodic phrase searching unit 430 searches out one boundary data candidate that maximizes the product of the first and second likelihoods (S540). The boundary data candidate maximizing the product may be searched out by: calculating products of the first and second likelihoods for all of combinations (i.e. when N denotes the number of words, 2^{N-1} combinations) of words, the combinations being assumable as the boundary data; and comparing magnitudes of values of the products. In detail, the prosodic phrase searching unit 430 may search out one boundary data candidate maximizing the first and second likelihoods by using a conventional method known as the Viterbi algorithm. Further, the prosodic phrase searching unit 430 may calculate the first and second likelihoods regarding only a part of the entire word combinations that are assumable as the boundary data. Thereafter the prosodic phrase searching unit 430 may calculate one word combinations maximizing the product of the thus found first and second likelihoods, as the boundary data indicating the word combinations that approximately maximizes the first and second likelihoods. The boundary data searched out indicates prosodic phrases having the maximum likelihood for the input text 15 and the input speech 18.

Subsequently, the third calculation unit 440, the fourth calculation unit 450 and the accent type searching unit 460 performs the following processing for each of prosodic phrases segmented by the boundary data searched out by the prosodic phrase searching unit 430. First of all, candidates for accent types of each of the words contained in a prosodic phrase are inputted into the third calculation unit 440. As in the case with the above described boundary data, it is also desirable that all of the combinations, assumed to function as accent types, of the words composing the prosodic phrases be sequentially inputted as plural candidates for the accent types. The third calculation unit 440 calculates the third likelihood for each of the inputted candidates for the accent types, on the basis of the inputted-speech data, the training wording data 200 and the training accent data 240. The third likelihood indicates the likelihood that accent types of the words in the prosodic phrase agree with each of the inputted candidates for the accent types (S540). As has been described above, this calculation of the third likelihood corresponds to calculation of P(A|W) shown in the third line of Equation 2. This calculation is implemented by calculating Equation 5 shown below.

$${P}^{′} ( A \vert W ) = \frac{{P}^{′} ( A \vert W )}{{\sum }_{A} {P}^{′} ( A \vert W )} \qquad Equation 5$$

In this Equation 5, the vector variable A indicates the combination of the accent types of each of the words in the prosodic phrase. Elements of this vector variable A indicate the accent types of each of the words in the prosodic phrase. That is, when wᵢ denotes a word arranged at the i-th position in the prosodic phrase, and n denotes the number of words in the prosodic phrase, A is expressed as A=(A₁, . . . , Aₙ). P′ (A|W) indicates, with respect to a combination W of wordings of given words, the likelihood that speech of the combination of these wordings agrees with speech of the combination A of the accent types. Equation 5 is used to make the total of the likelihoods for each combination equal to 1, in a case where the likelihoods are not normalized and their total are not equal to 1 for convenience in using the calculation method. P′ (A|W) is defined by Equation 6 shown below.

$${P}^{′} ( A \vert W ) = {\prod }_{i = 1}^{n} P ( {A}_{i} \vert {A}_{1} , … , {A}_{i - 1} , {W}_{1} , … , {W}_{i} ) \qquad Equation 6$$

Equation 6 indicates, with respect to each word Wi, a conditional probability that, on condition that accent types of words W₁ to Wᵢ₋₁ in a group of words obtained by scanning the prosodic phrase until the scanning reaches this word W₁ are A₁ to Aᵢ₋₁, an accent type of the i-th word is Aᵢ. This means that, as the value i approaches the termination of a prosodic phrase, all of the words having been scanned to this point are set as a condition for calculation of the probability. In addition, this indicates that the thus calculated conditional probabilities for all of the words in the prosodic phrase are multiplied together. Each of the conditional probabilities can be implemented by the third calculation unit 400 performing the following steps: searching, from a plurality of locations, the wording in which the words W₁ to Wᵢ are connected together out of the training wording data 200; searching accent types of each word from the training accent data 240; and calculating appearance frequencies of each of the accent types. However, in a case where the number of words in the prosodic phrase is large, that is, in a case where the value i may become large, it is difficult to find in the training wording data 200, the word combinations with a wording perfectly matching the wording of a part of the input text 15. For this reason, it is desirable that a value shown in Equation 6 be approximately found.

Specifically, the third calculation unit 440 may calculate, on the basis of the training wording data 200, the appearance frequencies of respective word combinations formed of n words where n is a predetermined number, and then use these appearance frequencies in calculating appearance frequencies of combinations including words more than the predetermined number n. With n denoting the number of words composing each of the word combinations, this method is called an ngram model. In a bigram model where the number of words is two, the third calculation unit 440 calculates an appearance frequency, in the training accent data 240, at which each combination of two words continuously written in the training text is spoken by a corresponding combination of accent types. Then, by using each of the calculated appearance frequencies, the third calculation unit 440 approximately calculates a value of P′ (A|W). As one example, for each word in the prosodic phrase, the third calculation unit 440 selects the value of the appearance frequency that is previously calculated by use of the bigram model for the combination of the concerned word and its next word continuously written. Then, the third calculation unit 440 obtains P′ (A|W) by multiplying together the thus selected values of the appearance frequency.

FIG. 5 will be referred to here again. Next, on the basis of the inputted-speech data, the training speech data 210 and the training accent data 240, the fourth calculation unit 450 calculates the fourth likelihood for each of the inputted candidates for the accent types (S560). The fourth likelihood is the likelihood that, in a case where the words in the prosodic phrase have accent types specified by the candidates for the accent types, speech of the prosodic phrase agrees with speech specified by the inputted-speech data. As has been described above, this calculation of the fourth likelihood corresponds to P(V|W,A) shown in the third line of Equation 2, and is expressed as Equation 7 shown below.

$$\begin{matrix}P ( V \vert W , A ) = {\prod }_{i = 1}^{m} P ( {v}_{i} \vert W , A ) \\ = {\prod }_{i = 1}^{m} P ( {v}_{i} \vert {a}_{i - 1} , {a}_{i} , m , i , ( m - i ) )\end{matrix} \qquad Equation 7$$

In Equation 7, definitions of the vector variables V, W and A are the same as those described above. Note that, the variable vᵢ, which is an element of the vector variable V, indicates the characteristics of speech of each mora i with including, as a suffix, a variable i specifying a mora in a prosodic phrase. Additionally, vᵢ may denote different kinds of characteristics in Equations 7 and 4. Also, the variable m indicates the total number of moras in the prosodic phrase. The left-hand side of the first line of Equation 7 is approximated to the expression on the right-hand side thereof on the assumption that the characteristics of speech of each mora are independent of the mora adjacent thereto. The right-hand side of the first line in Equation 7 expresses that the likelihood indicating characteristics of speech of the prosodic phrases are calculated by multiplying together likelihoods based on the characteristics of each of the moras.

As shown in the second line of Equation 7, instead of the actual wordings of the words, W may be approximated by the number of moras in each word in the prosodic phrase, or by the position each mora occupies in the prosodic phrase. That is, in a condition part which is the right side to “|” in Equation 7, the variable i indicates the position of mora i, that is, how many moras exist from the first mora to mora i in the prosodic phrase. (m−i) indicates the position of mora i, that is, how many moras exist from mora i to the last mora in the prosodic phrase. Additionally, in the condition part in the equation, the variable aᵢ indicates which of the H or L type the accent of the i-th mora in the prosodic phrase is. This condition part includes the variables aᵢ and aᵢ₋₁. That is, in this equation, A is determined by a combination of adjacent two moras, not by all of combinations of accents concerning all of moras in the prosodic phrase.

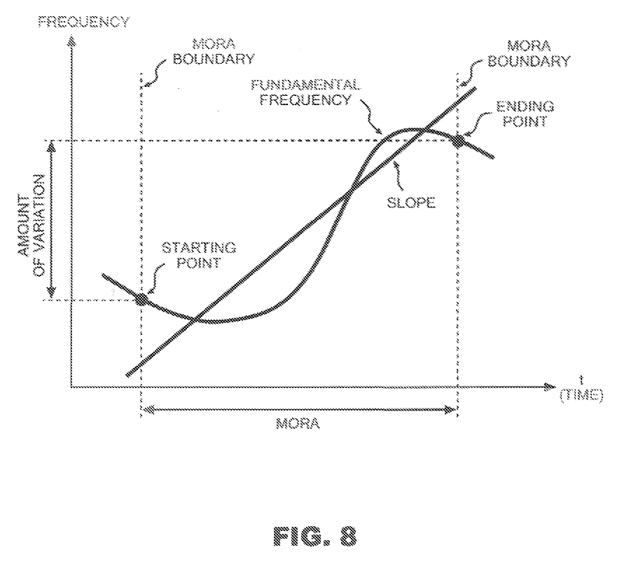

Next, in order to explain a method of calculating this probability density function P, a specific example of each of indicators indicated by the variable vᵢ in this embodiment will be described with reference to FIG. 8.

FIG. 8 shows one example of a fundamental frequency of a certain mora subjected to accent recognition. As in the case with FIG. 7, the horizontal axis represents a direction of elapse of time, and the vertical axis represents a magnitude of a fundamental frequency of speech. The curved line in the drawing indicates time series variation in the fundamental frequency in the certain mora. Additionally, the dotted line in the drawing indicates a boundary between this mora and another mora. A vector variable vᵢ indicating characteristics of speech of this mora i indicates, for example, a three-dimensional vector whose elements are index values of three indicators. A first indicator indicates a value of the fundamental frequency of speech in this mora at the start thereof. A second indicator indicates an amount of change in the fundamental frequency of speech in this mora i. This amount of change is the difference between values of the fundamental frequency at the start of this mora i and at the end thereof. This second indicator may be normalized as a value in the range of 0 to 1 by a calculation shown in Equation 8 below.

$$F 0 = \frac{F 0 - F {0}_{min}}{F {0}_{max} - F {0}_{min}} \qquad Equation 8$$

According to this Equation 8, the difference between the values of the fundamental frequency at the start of the mora and at the end thereof is normalized, on the basis of the difference between a minimum and a maximum value of the fundamental frequency, as a value in the range of 0 to 1.

A third indicator indicates a change in the fundamental frequency of speech over time in this mora, that is, a slope of the straight line in the graph. In order to grasp a general tendency of the curved line showing change in the fundamental frequency, this line may be obtained by approximating the curved line of the fundamental frequency to a linear function by the least square method or the like. Instead of the actual fundamental frequency and amount of change thereof, their logarithms may be employed as the indicators. Additionally, for the training speech, the index values may be previously stored as the training speech data 210 in the storage unit 20, or may be calculated by the fourth calculation unit 450, on the basis of data of the fundamental frequency stored in the storage unit 20. For the input speech 18, the index values may be calculated by the fourth calculation unit 450.

On the basis of each of the indicators for the training speech, the training wording data 200 and the training accent data 240, the fourth calculation unit 450 generates a decision tree for determining the probability density function P shown on the right-hand side of the second line of Equation 7. This decision tree includes as explanatory variables: which of the H type or the L type an accent of a mora is; the number of moras in a prosodic phrase containing that mora; which of the H type or the L type the accent of another mora continuing from immediately before that mora is; and a position occupied by that mora in the prosodic phrase. This decision tree includes, as a target variable, a probability density function including, as a stochastic variable, a vector variable v indicating characteristics of speech for the case where each of the conditions is satisfied.

This decision tree is automatically generated when the above-mentioned explanatory variables and target variable are set after adding to software for constructing a decision tree the following information: the index values of each mora for the training speech; the training wording data 200; and the training accent data 240. As a result, generated by the fourth calculation unit 450 are plural probability density functions classified by every combination of values of the above-mentioned explanatory variables. Note that, because the index values calculated from the training speech assume discrete values in practice, the probability density functions may be approximately generated as a continuous function by such means as determining parameters of Gaussian mixture.

The fourth calculation unit 450 performs the following processing with respect to each mora by scanning from the beginning of the prosodic phrase, plural moras therein. First of all, the fourth calculation unit 450 selects one probability density function from among the probability density functions which are generated, classified by every combination of values of the explanatory variables. The selection of the probability density function is performed, on the basis of parameters corresponding to the above-mentioned explanatory variables such as: the number of moras in the prosodic phrases; and which of accent types H or L each mora has, in the inputted candidates for the accent type. Then, the fourth calculation unit 450 calculates a probability value by substituting, into the selected probability density function, the index values which indicate, in the input speech 18, characteristics of the each mora. Subsequently, the fourth calculation unit 450 calculates the fourth likelihood by multiplying together the probability values calculated for each of the moras thus scanned.

FIG. 5 will be referred to here again. Subsequently, the accent type searching unit 460 searches out one candidate for the accent types from among the inputted plural candidates for the accent types. The one candidate searched out maximizes the product of the third likelihood calculated by the third calculation unit 440 and the fourth likelihood calculated by the fourth calculation unit 450 (S570). This searching may be implemented by calculating products of the third and fourth likelihoods for each of the candidates for the accent types, and thereafter, specifying a candidate that corresponds to the maximum one of these products. Alternatively, as in the case with the above described searching for a boundary of a prosodic phrase, this searching may be performed by use of the Viterbi algorithm.

The above processing is repeated for every prosodic phrase searched out by the prosodic phrase searching unit 430, and consequently, accent types of each of the prosodic phrases in the input text 15 are outputted.

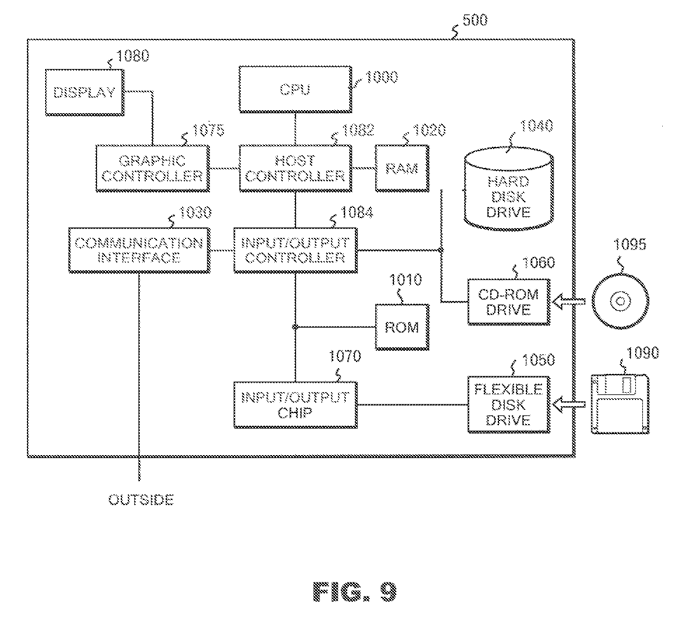

FIG. 9 shows one example of a hardware configuration of the information processing apparatus 500 which functions as the recognition system 10. The information processing apparatus 500 includes: a CPU peripheral section including the CPU 1000, the RAM 1020 and a graphic controller 1075 which are mutually connected by a host controller 1082; an input/output section including a communication interface 1030, a hard disk 1040, and a CD-ROM drive 1060 which are connected to the host controller 1082 by an input/output controller 1084; and a legacy input/output section including a ROM 1010, a flexible disk drive 1050 and an input/output chip 1070 which are connected to the input/output controller 1084.

The host controller 1082 mutually connects the RAM 1020 with the CPU 1000 and the graphic controller 1075 which access the RAM 1020 at high transfer rates. The CPU 1000 operates on the basis of the programs stored in the ROM 1010 and RAM 1020, and thereby performs control over the respective sections. The graphic controller 1075 acquires image data generated by the CPU 1000 or the like on a frame buffer provided in the RAM 1020, and displays the image data on a display 1080. Instead, the graphic controller 1075 may include, inside itself, a frame buffer in which the image data generated by the CPU 1000 or the like is stored.

The input/output controller 1084 connects the host controller 1082 with the communication interface 1030, the hard disk drive 1040 and the CD-ROM drive 1060 which are relatively high speed input/output device. The communication interface 1030 communicates with an external apparatus through a network. The hard disk drive 1040 stores programs and data which are used by the information processing apparatus 500. The CD-ROM drive 1060 reads a program or data from a CD-ROM 1095, and provides the program or data to the RAM 1020 or the hard disk drive 1040.

Additionally, the ROM 1010, and relatively low speed input/output device, such as the flexible disk drive 1050 and the input/output chip 1070, are connected to the input/output controller 1084. The ROM 1010 stores: a boot program executed by the CPU 1000 at the startup of the information processing apparatus 500; and other programs dependent on hardware of the information processing apparatus 500; and the like. The flexible disk drive 1050 reads a program or data from a flexible disk 1090, and provides the program or data through the input/output chip 1070 to the RAM 1020 or to the hard disk drive 1040. The input/output chip 1070 connects, to the CPU 1000, the flexible disk 1090, and various kinds of input/output devices through, a parallel port, a serial port, a keyboard port, a mouse port and the like.

A program is provided by a user to the information processing apparatus 500 stored in a recording medium such as the flexible disk 1090, the CD-ROM 1095, or an IC card. The program is executed after being read from the recording medium through at least any one of the input/output chip 1070 and the input/output controller 1084, and then being installed in the information processing apparatus 500. Description on operations which the program causes the information processing apparatus 500 to perform will be omitted since these operations are identical to those in the recognition apparatus 10 which have been described in connection with FIGS. 1 to 13.

The program described above may be stored in an external recording medium. As the recording medium, other than the flexible disk 1090 and the CD-ROM 1095, it is possible to use: an optical recording medium such as a DVD or a PD; a magneto optical recording medium such as an MD; a tape medium; a semiconductor memory such as an IC card; or the like. Additionally, it is also possible to provide the program to the information processing apparatus 500 through a network by using as the recording medium a recording device, such as a hard disk or a RAM, provided in a server system connected to a dedicated communication network or the Internet.

As has been described above, according to the recognition apparatus 10 of this embodiment, a boundary of a prosodic phrase can be efficiently and highly accurately searched out by combining linguistic information, such as wordings and part-of-speeches of words, and acoustic information, such as change in frequency of pronunciation. Furthermore, for each of the prosodic phrases searched out, accent types can be efficiently and highly accurately searched out by combining the linguistic information and the acoustic information. As a result of actually carrying out an experiment using an inputted text and an inputted speech in which boundaries and accent types of prosodic phrases are previously known, it was confirmed that highly accurate recognition results were obtained which were considerably approximate to these previously known information. Additionally, in comparison with a case where the linguistic information and the acoustic information are used independently, it was confirmed that a combined use of these information enhances the accuracy of recognition.

Although the present invention has been described above by using the embodiment, the technical scope of the present invention is not limited to the scope in the above described embodiment. It is obvious to one skilled in the art that a variety of alterations and improvements can be added to the above described embodiment. Additionally, it is obvious from the description in the scope of claims that embodiments with alterations or improvements added thereto can also be incorporated in the technical scope of the present invention.

1. A system for recognizing accents of an inputted speech, comprising:
a storage unit which stores training wording data indicating the wording of each of the words in a training text, training speech data indicating characteristics of speech of each of the words in a training speech, and training boundary data indicating whether each of the words is a boundary of a prosodic phrase;
a first calculation unit into which boundary data candidates indicating whether each of the words in the inputted speech is a boundary of a prosodic phrase are inputted, and which calculates a first likelihood that each of boundaries between prosodic phrases of words in an inputted text would agree with one of the inputted boundary data candidates, on the basis of inputted-wording data indicating the wording of each of the words in the inputted text indicating contents of the inputted speech, the training wording data, and the training boundary data;
a second calculation unit into which the boundary data candidates are inputted, and which calculates a second likelihood that, in a case where the inputted speech has a boundary of a prosodic phrase specified by any of the boundary data candidates, speech of each of the words in the inputted text would agree with speech specified by the inputted-speech data, on the basis of inputted-speech data indicating characteristics of speech of each of the words in the inputted speech, the training speech data and the training boundary data; and
a prosodic phrase searching unit which searches out a set of boundary data candidates maximizing a product of the first and second likelihoods, from among the inputted boundary data candidates, and which outputs the searched-out boundary data candidate as boundary data for sectioning the inputted text into prosodic phrases.

2. The system according to claim 1, wherein the storage unit further stores therein training part-of-speech data indicating the part-of-speech of each of the words in the training text and
the first calculation unit calculates the first likelihood also on the basis of the training part-of-speech data.

3. The system according to claim 2, wherein the first calculation unit generates a decision tree for calculating the likelihood that each word would be a boundary of a prosodic phrase on the basis of the training wording data, the training part-of-speech data and the training boundary data; calculates, on the basis of the decision tree, the likelihoods of the respective prosodic phrases indicated by the inputted boundary data candidates; and calculates a product of these calculated likelihoods as the first likelihood.

4. The system according to claim 1, wherein the inputted-speech data is an index value indicating the characteristic of speech of each word, and
on the basis of the training speech data and the training boundary data, the second calculation unit generates the probability density functions, each having the index values for a word as a stochastic variable, respectively for the cases where the word is a boundary of a prosodic phrase and where the word is not, then selects one of the probability density functions for each word in the inputted text on the basis of the boundary data candidates, and then calculates the second likelihood by calculating the probability for the corresponding index values by the probability density functions selected for each of the words, and thereafter multiplying together these probability density functions.

5. The system according to claim 4, wherein
each word includes at least one mora as a pronunciation thereof,
for each word contained in the training text, the storage unit stores therein, as the index values indicating the characteristics of speech thereof, an index value indicating change over time in a fundamental frequency in the first mora of a word following each word, a difference between the index value and an index value indicating change over time in a fundamental frequency in the last mora of the each word, and an amount of change in a fundamental frequency in the last mora of each word,
the second calculation unit uses, as a stochastic variable, a vector variable which contains the plurality of indicators as elements, and
for cases where a word is a boundary of a prosodic phrase, and where the word is not, the second calculation unit calculates the probability density functions each indicating probability that speech of the word would agree with speech specified by combinations of the index values in a corresponding case, by using, as stochastic variables, vector variables which contain as elements the indicators for the word in the two cases, and by determining Gaussian mixture parameters.

6. The system according to claim 1, further comprising a preferential judgment unit, wherein
the first calculation unit further calculates the first likelihood for a test text instead of the inputted text, and for test speech data, in which a boundary of a prosodic phrase has been previously recognized, instead of the inputted-speech data,
the second calculation unit further calculates the second likelihood by using the test text instead of the inputted text, and by using the test speech data instead of the inputted-speech data,
the preference judging unit judges one of the first and second calculation units as a preferential calculation unit that should be preferentially used, the one calculation unit having calculated a higher likelihood for the previously recognized boundary of a prosodic phrase in the test speech data, and
the prosodic phrase searching unit calculates the product of the first and second likelihoods after assigning a larger weight to the likelihood calculated by the preferential calculation unit.

7. The system according to claim 1, further comprising a third calculation unit, a fourth calculation unit and an accent type searching unit, wherein
the storage unit further stores therein training accent data indicating the accent type of each of the words in the training speech, and
with respect to each of prosodic phrases sectioned by the boundary data searched out by the prosodic phrase searching unit,
the third calculation unit receives inputs of candidates for accent types of the respective words contained in the each prosodic phrase, and calculates a third likelihood that the accent type of each of the words would agree with one of the inputted candidates for the accent types, on the basis of the inputted-speech data, the training wording data and the training accent data,
the fourth calculation unit receives inputs of the candidates for the accent types, and calculates a fourth likelihood that, in a case where each of the words contained in the each prosodic phrase has the accent type specified by one of the candidates for the accent types, speech of the each prosodic phrase would agree with speech specified by the inputted-speech data, on the basis of the inputted-speech data, the training speech data and the training accent data, and
the accent type searching unit searches out one candidate for an accent type maximizing a product of the third and fourth likelihoods, from among the inputted candidates for the accent types, and outputs the searched-out candidate for the accent types as the accent types of the each prosodic phrase.

8. The system according to claim 7, wherein the third calculation unit calculates a frequency at which each of combinations of at least two words continuously written in the training text has been spoken by one of the combinations of accent types in the training accent data, and then calculates the third likelihood on the basis of the calculated frequencies.

9. The system according to claim 7, wherein
each of the words includes at least one mora as a pronunciation thereof,
the storage unit stores therein, as the training speech data, index values indicating a characteristic of speech of each mora, and
the fourth calculation unit calculates the fourth likelihood: by classifying an accent of each mora into one of an high type and an low type in accordance with the number of moras contained in a prosodic phrase containing the each mora, and the position of the each mora in the prosodic phrase; by calculating probability density functions each having the index values of this mora as a random variable; by selecting one of the probability density functions on the basis of which accent type, the H type or L type each mora of each word contained in the prosodic phrase has in the inputted candidates for the accent types, the number of moras of the prosodic phrase containing the each mora, and the position of the each mora in the prosodic phrase; by calculating the probability values by assigning the index values, which indicate characteristics of speech of the each mora, to the probability density function selected correspondingly to the each mora; and by multiplying the calculated probability values together.

10. The system according to claim 9, wherein
the storage unit stores therein, as the index values indicating characteristics of speech of each mora of each word contained in the training text, a fundamental frequency of speech at the beginning of each mora, an index value indicating an amount of change in the fundamental frequency of speech in each mora, and an index value indicating an amount of change in the fundamental frequency of speech over time in each mora, and
in a case where an accent of a mora agrees with one of inputted candidates for the accent types, the fourth calculation unit generates probability density functions on the basis of the training speech data and the training accent data, the probability density functions each having, as a stochastic variable, a vector variable which contains the plural indicators as elements, and each indicating a probability that speech of this mora has one of the characteristics specified by the vector variable.

11. A method of recognizing accents of an inputted speech, comprising the steps of:
storing, in a memory, training wording data indicating the wording of each of the words in a training text, training speech data indicating characteristic of speech of each of the words in a training speech, and training boundary data indicating whether each of the words is a boundary of a prosodic phrase;
causing a CPU to input candidates for boundary data candidates indicating whether each of the words in the inputted speech is a boundary of a prosodic phrase, and to calculate a first likelihood that each of the boundary of a prosodic phrase of the words in the inputted text would agree with one of the inputted boundary data candidates, on the basis of inputted-wording data indicating the wording of each word in an inputted text indicating contents of the inputted speech, the training wording data and the training boundary data;
causing the CPU to input the boundary data candidates, and to calculate a second likelihood, in a case where the inputted speech has a boundary of a prosodic phrase specified by one of the candidate for the boundary data, that speech of each of the words in the inputted text would agree with speech specified by the inputted-speech data, on the basis of inputted-speech data indicating characteristics of speech of each of the words in the inputted speech, the training speech data and the training boundary data; and
causing the CPU to search out one boundary data candidate maximizing a product of the first and second likelihoods, from among the inputted boundary data candidates, and outputs the searched-out boundary data candidate as boundary data for sectioning the inputted text into prosodic phrases.

12. A program allowing an information processing apparatus to function as a system for recognizing accents of an inputted speech, the program causing the information processing apparatus to function as:
a storage unit which stores therein, training wording data indicating the wording of each of the words in a training text, training speech data indicating characteristics of speech of each of the words in a training speech, and training boundary data indicating whether each of the words is a boundary of a prosodic phrase;
a first calculation unit into which boundary data candidates indicating whether each of the words in the inputted speech is a boundary of a prosodic phrase are inputted, and which calculates a first likelihood that each of a boundary of a prosodic phrase of words in an inputted text would agree with one of the inputted boundary data candidates, on the basis of inputted-wording data indicating the wording of each of the words in the inputted text indicating contents of the inputted speech, the training wording data, and the training boundary data;
a second calculation unit into which the boundary data candidates are inputted, and which calculates a second likelihood that, in a case where the inputted speech has a boundary of a prosodic phrase specified by any of the boundary data candidates, speech of each of the words in the inputted text would agree with speech specified by the inputted-speech data, on the basis of inputted-speech data indicating characteristics of speech of each of the words in the inputted speech, the training speech data and the training boundary data; and
a prosodic phrase searching unit which searches out one boundary data candidate maximizing a product of the first and second likelihoods, from among the inputted boundary data candidates, and which outputs the searched-out boundary data candidate as boundary data for sectioning the inputted text into prosodic phrases.
